(19) United States
(12) Patent Application Publication
(10) Pub. No.: US 2008/0174044 A1
(43) Pub. Date: Jul. 24, 2008

(54) METHOD FOR FORMING A CORE VESSEL WITH DIFFERENT COLORS

(76) Inventor: Ying-Hui Shen, Tainan Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/626,584

(22) Filed: Jan. 24, 2007

(51) Int. Cl. B28B 1/24

(52) U.S. Cl. 264/255

(57) ABSTRACT

A method for forming a core vessel with different colors comprises the following steps: initially injection molding an inner parison by using a first die, wherein at the bottom of the inner parison is formed a cavity, placing the inner parison into a second die, by way of the colorful homogeneous material which differs from the color of the inner parison, further injection molding a core parison, wherein the top portion of the core parison which is joined together with the inner parison is fixed to the cavity of the inner parison, finally placing the combined inner and core parisons into a third die, and injection molding an outer parison, wherein the outer parison tightly covers the exteriors of the inner and core parisons, and the inner, core and outer parisons are completely combined together, such that after the finished vessel is released from the die, it will have a colorful suspended core therein.

### BACKGROUND OF THE INVENTION

1. Field of the Invention

The present invention relates to a method for forming a core vessel, and more particularly to a method for forming a core vessel with different colors that can form an integrally seamless acrylic vessel and its interior can form another color differing from the entire color of the vessel.

2. Description of the Prior Arts

In general, acrylic vessel products in the market include acrylic cups, acrylic boxes and the like, they are popular with the customers because of their high transparency. However, most acrylic vessel products can be merely formed a single color in the injection molding process, thus they gradually lose the attraction of the aesthetic appearance to the customers. To solve such a problem, an improved vessel with two different colors has been developed by manufacturers, nevertheless, its forming method is quite complicated, and the colorful appearance is not ideal.

The present invention has arisen to mitigate and/or obviate the afore-described disadvantages.

### SUMMARY OF THE INVENTION

The primary objective of the present invention is to provide a method for forming a core vessel with different colors, which can form a colorful suspended core in the vessel so as to enhance the user's purchase desire.

The method for forming a core vessel with different colors in accordance with the present invention includes the following steps:

A, initially forming an inner parison of a vessel by using one die: employing a first die (not shown) to injection mold an inner parison of a vessel, wherein the inner parison is made of transparent or semi-transparent acrylic material and at the bottom thereof is formed a cavity;

B, secondarily forming a core parison of the vessel by using another die: placing the inner parison into a second die (not shown), and by way of the colorful acrylic material which is different from the color of the acrylic material of the inner parison, injection molding a core parison, wherein the top portion of the core parison which is joined together with the inner parison is fixed to the cavity of the inner parison;

C, finally forming an outer parison of the vessel by using the other die: placing the combined inner and core parisons into a third die (not shown), and by means of the same transparent or semi-transparent acrylic material as the inner parison, injection molding an outer parison, wherein the outer parison tightly covers the exteriors of the inner and core parisons, and the inner, core and outer parisons are completely combined together without forming any seam therebetween, such that after the finished vessel is released from the die, it will have a colorful suspended core therein.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a cross sectional view illustrating the inner parison is formed in the initial injection-molding process;

FIG. 2 is an assembly cross sectional view illustrating the core and inner parisons are joined together in the second injection-molding process;

FIG. 3 is an assembly cross sectional view illustrating the outer, core and inner parisons are combined as a whole in the final injection-molding process;

FIG. 4 is a perspective view of a finished vessel in accordance with the present invention;

FIG. 5 is a perspective view of another finished vessel in accordance with the present invention.

### DETAILED DESCRIPTION OF THE PREFERRED EMBODIMENT

A method for forming a core vessel with different colors in accordance with the present invention comprises the following steps:

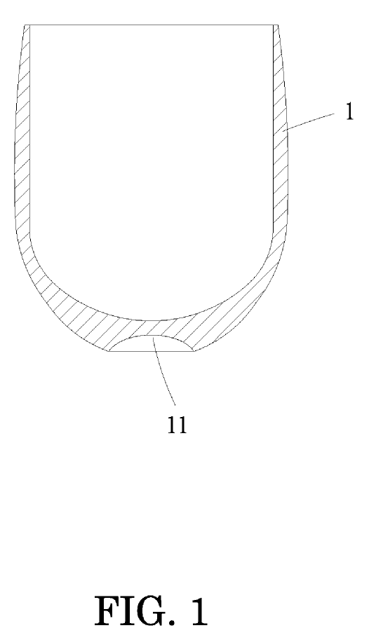

A, initially forming an inner parison of a vessel by using one die: employing a first die (not shown) to injection mold an inner parison 1 of a vessel, as shown in FIG. 1, wherein the inner parison 1 is made of transparent or semi-transparent acrylic material, and at the bottom thereof is formed a cavity 11;

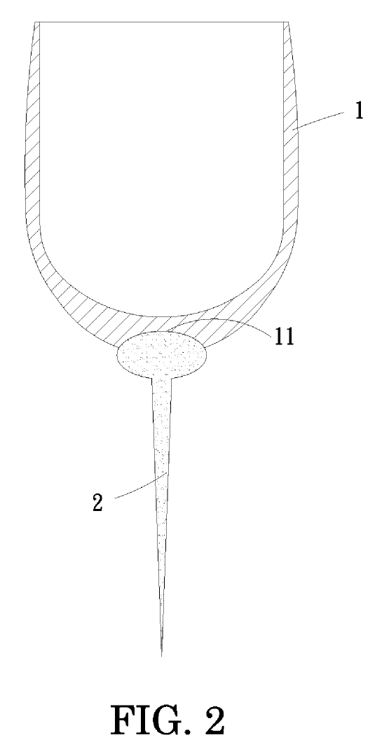

B, secondarily forming a core parison of the vessel by using another die: placing the inner parison 1 into a second die (not shown), and by way of the colorful acrylic material which is different from the color of the acrylic material of the inner parison 1, injection molding a core parison 2 as illustrated in FIG. 2, wherein the top portion of the core parison 2 which is joined together with the inner parison 1 is fixed to the cavity 111 of the inner parison 1;

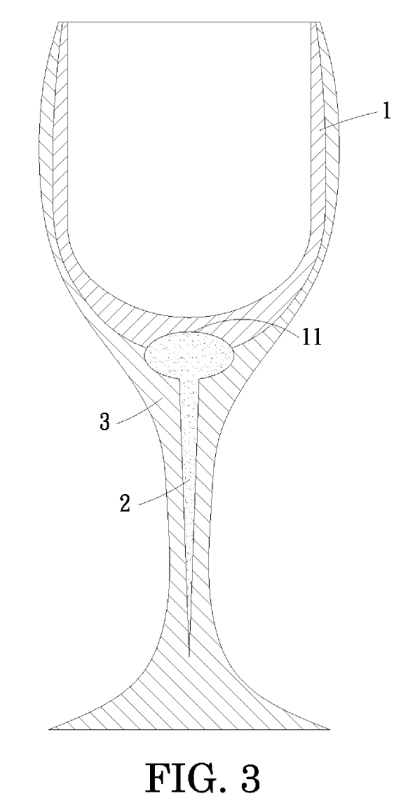

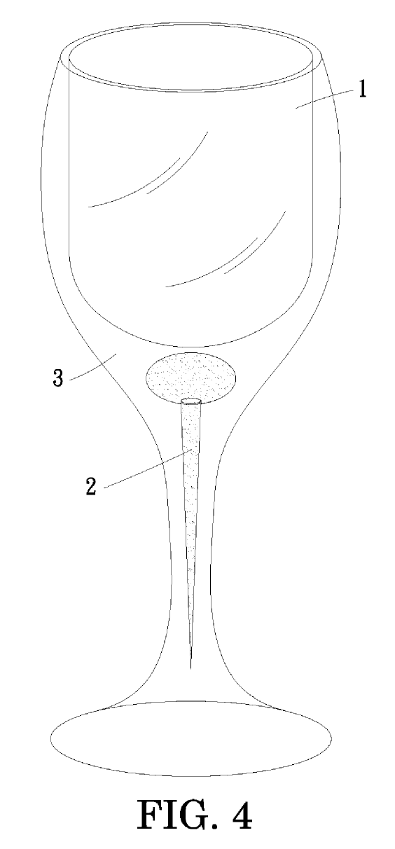

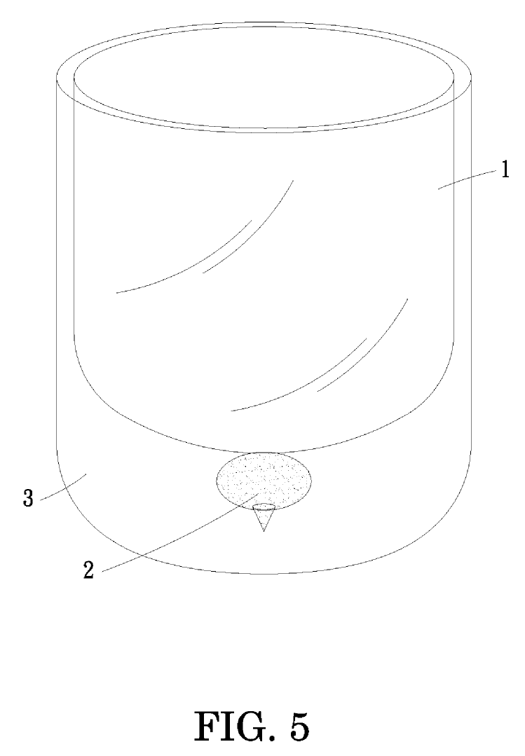

C, finally forming an outer parison of the vessel by using the other die: placing the combined inner and core parisons 1 and 2 into a third die (not shown), and by means of the same transparent or semi-transparent acrylic material as the inner parison 1, injection molding an outer parison 3 as shown in FIG. 3, wherein the outer parison 3 tightly covers the exteriors of the inner and core parisons 1 and 2, and the inner, core and outer parisons 1, 2 and 3 are completely combined together without forming any seam therebetween, such that after the finished vessel is released from the die, it will have a colorful suspended core therein, as illustrated in FIGS. 4 and 5.

It is concluded from the above-mentioned steps that the method for forming the core vessel with different colors of the present invention contains the following advantages:

First, the present invention is to apply three-step forming method to form a vessel with different colors in the inner core and exterior thereof, such that the inner core of the vessel will cause a colorful suspended appearance, thereby enhancing the user's purchase desire.

Second, by using the forming method of the present invention, an acrylic cup having different colors and a seamless structure therein can be created, thus complying with the novelty of the invention.

Third, by virtue of injection molding technology, the homogeneous inner, outer and core parisons of the vessel can be in turn combined as a whole so as to form an integrally seamless appearance, thereby enhancing the user's collection desire.

The invention is not limited to the above embodiment but various modifications thereof may be made. It will be understood by those skilled in the art that various changes in form and detail may made without departing from the scope and spirit of the present invention.

What is claimed is:

1. A method for forming a core vessel with different colors comprising the following steps:
A, initially forming an inner parison of a vessel by using one die: employing a first die (not shown) to injection mold an inner parison of a vessel, wherein at the bottom of said inner parison is formed a cavity;
B, secondarily forming a core parison of the vessel by using another die: placing said inner parison into a second die (not shown), and by way of the colorful homogeneous material which is different from the color of said inner parison, injection molding a core parison, wherein the top portion of said core parison which is joined together with said inner parison is fixed to said cavity of said inner parison;
C, finally forming an outer parison of the vessel by using the other die: placing the combined inner and core parisons into a third die (not shown), and by means of the same colorful homogeneous material as said inner parison, injection molding an outer parison, wherein said outer parison tightly covers the exteriors of said inner and core parisons, and said inner, core and outer parisons are completely combined together without forming any seam therebetween, such that after the finished vessel is released from the die, it will have a colorful suspended core therein.

2. The method for forming a core vessel with different colors as claimed in claim 1, wherein said inner parison is made of acrylic material.

3. The method for forming a core vessel with different colors as claimed in claim 2, wherein said inner parison is transparent or semi-transparent.

4. The method for forming a core vessel with different colors as claimed in claim 3, wherein said outer parison is transparent or semi-transparent like said inner parison.
